(19) United States
(12) Patent Application Publication
(10) Pub. No.: US 2025/0156624 A1
(43) Pub. Date: May 15, 2025

(54) CIRCUIT LAYOUT VERIFICATION METHOD AND SYSTEM

(71) Applicant: Raydium Semiconductor Corporation, Hsinchu (TW)

(72) Inventors: Chi-Huang CHANG, Hsinchu (TW); Cheng-Ta LIN, Hsinchu (TW)

(21) Appl. No.: 18/939,785

(22) Filed: Nov. 7, 2024

(30) Foreign Application Priority Data
Nov. 14, 2023 (TW) 112143837

(51) Int. Cl. G06F 30/398; G06F 119/22

(52) U.S. Cl. CPC G06F 30/398; G06F 2119/22

(57) ABSTRACT

A method for circuit layout verification in a computing device includes: reading a circuit layout; setting parameters for components in the circuit layout; according to a preset voltage value of at least one port in the circuit layout, performing DC analysis on the circuit layout after the setting is performed to calculate a maximum possible voltage value and a minimum possible voltage value of a wire segment on the circuit layout; and inputting the maximum possible voltage value and the minimum possible voltage value into a predetermined design specification, wherein when the maximum possible voltage value or minimum possible voltage value exceeds the predetermined design specification, the wire segment is marked as abnormal.

### CROSS-REFERENCE TO RELATED APPLICATION

This application claims the priority benefit of Taiwan application serial no. 112143837 filed on Nov. 14, 2023. The entirety of the above-mentioned patent application is hereby incorporated by reference herein and made a part of this specification.

### BACKGROUND

### Technical Field

The present invention relates to a circuit layout verification method and a circuit layout verification system, and in particular to a circuit layout verification method and a circuit layout verification system that use a direct current (DC) electrical transmission simulation.

### Related Art

In the process of laying out a circuit (for example, an integrated circuit or a circuit on a board), the design of each circuit trace in the layout needs to be determined by considering many parameters. For example, the circuit traces themselves and the surrounding voltage environment in integrated circuits have a great relationship with the yield and quality of chip manufacturing. The same integrated circuit can lead to performance or physical differences in energy consumption, yield or efficiency due to layout differences.

Therefore, after completing the circuit layout, it is often necessary to use some verification tools to inspect and test the circuit layout in accordance with the design rules to ensure that the manufactured chips can have the expected performance and that the yield will not be reduced due to poor layout. With the evolution of technology, the number of transistors or circuit components per unit area or volume has increased significantly, resulting in more and more complex circuit layouts. Therefore, the time required to verify the circuit layout and the computing resources of the computer have also increased significantly.

In addition, taking the verification tool of integrated circuit layout as an example, Simulation Program with Integrated Circuit Emphasis (SPICE) is often used to simulate the electrical characteristics of integrated circuit layout. However, the verification results of SPICE can often only present the design issues of the electrical characteristics in the circuit topology design, and cannot directly use SPICE to present the design issues of the electrical characteristics of the circuit layout in the circuit geometry design. For example, SPICE cannot be used to present the voltage relationship between layout traces. Therefore, there are still many tasks that rely on human judgment in the circuit geometry design. As the design of integrated circuits becomes increasingly complex, conducting such verification processes will put greater pressure on the designers or verifications.

From the above, it can be seen that in the verification of circuit layout, there are still many problems that need to be overcome.

### SUMMARY

Therefore, the present invention proposes a circuit layout verification method and a circuit layout verification system to effectively solve the problems encountered in the prior art.

More specifically, one object of the present invention is to provide a circuit layout verification method and a circuit layout verification system that are fast and reduce computational requirements.

Another object of the present invention is to provide a circuit layout verification method and a circuit layout verification system that can verify design problems in the circuit geometry design, so as to reduce the operating cost of manual judgment required in the prior art.

According to a preferred embodiment of the present invention, a circuit layout verification method is performed on a computing device. In this embodiment, the circuit layout verification method includes: reading a circuit layout; setting parameters for components in the circuit layout; according to a preset voltage value of at least one port in the circuit layout, performing a direct current (DC) analysis on the circuit layout after the setting is performed to calculate a maximum possible voltage value and a minimum possible voltage value of a wire segment in the circuit layout; and inputting the maximum possible voltage value and the minimum possible voltage value into a predetermined design specification, wherein when the maximum possible voltage value or the minimum possible voltage value exceeds the predetermined design specification, the wire segment is marked as abnormal. The setting is based on the following conditions: a voltage difference between a first electrode and a third electrode of a transistor in the circuit layout is equivalent to a transistor voltage drop, a resistor in the circuit layout is considered as a short circuit, and a voltage difference between an anode and a cathode of a diode in the circuit layout is equivalent to a diode voltage drop.

According to another preferred embodiment of the present invention is a circuit layout verification system. In this embodiment, the circuit layout verification system includes a storage unit and a processor. The storage unit is configured to store an instruction set and a circuit layout, and the processor is coupled to the storage unit and configured to read the instruction set to perform the following operations: reading a circuit layout; setting parameters for components in the circuit layout; according to a preset voltage value of at least one port in the circuit layout, performing a direct current (DC) analysis on the circuit layout after the setting is performed to calculate a maximum possible voltage value and a minimum possible voltage value of a wire segment in the circuit layout; and inputting the maximum possible voltage value and the minimum possible voltage value into a predetermined design specification, wherein when the maximum possible voltage value or the minimum possible voltage value exceeds the predetermined design specification, the wire segment is marked as abnormal. The setting is based on the following conditions: a voltage difference between a first electrode and a third electrode of a transistor in the circuit layout is equivalent to a transistor voltage drop, a resistor in the circuit layout is considered as a short circuit, and a voltage difference between an anode and a cathode of a diode in the circuit layout is equivalent to a diode voltage drop.

In one embodiment, the transistor voltage drop is 0V.

In one embodiment, the diode voltage drop is 0V.

In one embodiment, the setting is further based on that: an output end of an inverter in the circuit layout is considered as an appointed stop point.

In one embodiment, the setting is further based on that: a capacitor in the circuit layout is considered as an open circuit, and an inductor in this circuit layout is considered as a short circuit.

In one embodiment, the setting is further based on that: a bipolar junction transistor in this circuit layout is considered as a forward conduction according to a direction of current flow.

Compared with the prior art, the circuit layout verification method and system of the present invention modulate settings for components in the circuit layout (for example, passive components, diodes, transistors or gates). Modulating settings can assign preset parameters to circuit components and feedback the components with preset parameters to the original circuit layout for DC analysis. The components in the circuit are assigned preset parameters, which can simplify the complexity of the original circuit layout while verifying the maximum and minimum voltages that the circuit can tolerate. Simplifying the complexity can effectively reduce the computing resources required by the computer or system and reduce the time required for verification. In addition, verifying the maximum and minimum voltages that the circuit can tolerate and importing them into predetermined design specifications, and marking abnormal locations, can effectively reduce the operating cost of manual judgment required by the prior art.

The circuit layout verification method and system of the present invention can simplify the verification process. Compared with the verification tools used in the prior art, the present invention is beneficial to the early proof of concept (POC) of circuit design. In other words, in the POC stage, what designers often need is not 100% verification accuracy, but to quickly detect unreasonable aspects in the layout design. Therefore, the circuit layout verification method and system proposed by the present invention that simplify the verification process can enable layout designers to quickly verify early design results.

### BRIEF DESCRIPTION OF THE DRAWINGS

The drawings presented in this invention are intended to assist in describing various embodiments of the invention. However, in order to simplify the drawings and/or highlight the content to be presented in the drawings, conventional structures and/or components in the drawings may be drawn in a simple schematic manner or may be omitted. On the other hand, the number of components in the drawings may be singular or plural. The drawings presented in this invention are for the purpose of illustrating the embodiments only and are not limiting thereof.

FIG. 1 is a flow chart of a circuit layout verification method in a first embodiment of the present invention.

FIG. 2 shows the settings of a circuit composed of resistors according to the first embodiment.

FIG. 3 shows the settings of a circuit composed of transistors according to the first embodiment.

FIGS. 4A to 4D show the settings of a circuit composed of diodes according to the first embodiment.

FIG. 5 shows the settings of a circuit taking an inverter as an example according to the first embodiment.

FIG. 6 shows the settings of a circuit composed of passive components according to the first embodiment.

FIG. 7 shows a schematic diagram of the correspondence between a circuit diagram and a circuit layout diagram according to the first embodiment.

FIG. 8 is a schematic diagram of a circuit layout verification system in a second embodiment of the present invention.

### DETAILED DESCRIPTION

Any reference herein to elements using names such as “first”, “second”, etc. generally does not limit the number or order of these elements. Rather, these names are used herein as a convenient way to distinguish between two or more elements or instances of elements. Therefore, it should be understood that the names “first,” “second,” etc. in the claims do not necessarily correspond to the same names in the written description. Furthermore, it should be understood that reference to first and second components does not imply that only two components may be employed or that the first component must precede the second component. The words “comprising”, “including”, “has”, “contains”, etc. used herein are all open terms, which mean including but not limited to thereof.

The term “coupled” is used herein to refer to a direct or indirect electrical coupling between two structures. For example, in one example of indirect electrical coupling, one structure may be coupled to another structure via passive components such as resistors, capacitors, or inductors.

The words “exemplary” and/or “example” are used herein to mean “serving as an example, instance, or illustration.” Any aspect described herein as “exemplary” and/or “example” is not necessarily to be construed as preferred or advantageous over other aspects. The terms “about” and “approximately” as used herein with respect to a specified value or characteristic are intended to mean within a certain numerical value (e.g. 10%) of the specified value or characteristic.

According to a first specific embodiment of the present invention, a circuit layout verification method is performed on a computing device. In this embodiment, parameters for components in the circuit layout are set; after setting the parameters, a DC analysis is performed on the circuit layout to calculate the maximum possible voltage value and a minimum possible voltage value of a wire segment in the circuit layout; the maximum possible voltage and the minimum possible voltage are compared with a predetermined design specification. Therefore, the computing resources required by the computer or system can be reduced, the time required for verification can be reduced, and the operating cost of manual judgment required by the prior art can be reduced, but it is not limited thereto.

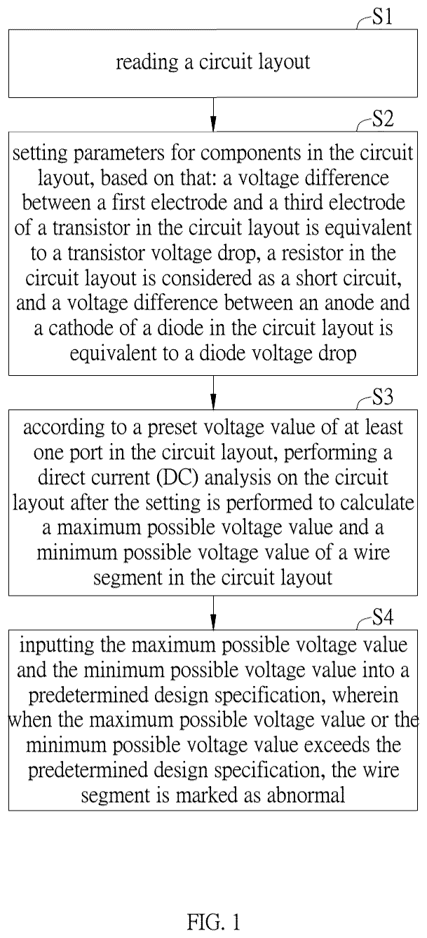

FIG. 1 is a flow chart of a circuit layout verification method in a first embodiment of the present invention. As shown in FIG. 1, the circuit layout verification method includes: (Step S1) reading a circuit layout, (Step S2) setting parameters for components in the circuit layout, based on that: a voltage difference between a first electrode and a third electrode of a transistor in the circuit layout is equivalent to a transistor voltage drop, a resistor in the circuit layout is considered as a short circuit, and a voltage difference between an anode and a cathode of a diode in the circuit layout is equivalent to a diode voltage drop, (Step S3) according to a preset voltage value of at least one port in the circuit layout, performing a direct current (DC) analysis on the circuit layout after the setting is performed to calculate a maximum possible voltage value and a minimum possible voltage value of a wire segment in the circuit layout, and (Step S4) inputting the maximum possible voltage value and the minimum possible voltage value into a predetermined design specification, wherein when the maximum possible voltage value or the minimum possible voltage value exceeds the predetermined design specification, the wire segment is marked as abnormal.

Regarding Step S1, the present invention is not limited to the type and size of the circuit. For example, the circuit layout of the present invention can be a nanometer-level integrated circuit layout on a wafer (semiconductor substrate), or a micron-level to millimeter-level circuit layout on a printed circuit board (PCB). The circuit layout referred to in the present invention may be files (data) designed and exported through conventional circuit layout design software (for example, Cadence, OrCAD, Altium Designer). The present invention is not limited to the file format of the circuit layout. It should be understood that any file format used to describe the circuit layout in the prior art (for example, Gerber, HSPICE, or any drawing files) may fall within the scope of the present invention. The circuit layout is preferably stored in a storage unit (such as a memory, a hard disk, a magnetic disk, or an optical disk) of a computing device (such as a computer). The computing device can read the circuit layout by accessing the storage unit, but not limited thereto.

After reading the circuit layout, the type, location and connection relationship of each component in the circuit layout can be obtained. In Step S2, parameters for the components in the circuit layout are set. Specifically, each component in the circuit has one or more component parameters that can describe its electrical characteristics. For example, when the component is a resistor, the component parameters may be the resistance value, the voltage drop across the resistor, or the current value flowing through the resistor itself, or other parameters that will be considered during the DC circuit analysis. The read circuit layout can be modified through the computing device. For example, the circuit layout can be read in the form of a hardware description language. By adjusting values or parameters for each component defined in the hardware description language, the component parameters in the circuit layout can be set.

In the setting step, a voltage difference between a first electrode and a third electrode of a transistor in the circuit layout is equivalent to a transistor voltage drop. Specifically, in the setting step of the present invention, the first electrode and the third electrode of the transistor are respectively the input end and the output end of the corresponding transistor. Taking the conventional field effect transistor (FET) as an example, the field effect transistor has three external ends: drain electrode, gate electrode and source electrode. The gate electrode is usually used as the control end of the field effect transistor, while the drain and source electrodes are usually used as the input end or output end of the field effect transistor. In the circuit layout, the voltage difference between the first electrode and the third electrode of the transistor is considered as the transistor voltage drop. The transistor voltage drop can be expressed as the voltage difference between the input end and the output end of the transistor. In this way, complex transistor circuits can be simplified into voltage nodes to simplify analysis complexity. In this embodiment, the transistor voltage drop can even be zero volt (0V), thereby further simplifying the complexity of the analysis. It should be noted that the present invention is not limited to the type of transistor. The field effect transistor can be replaced by other transistors, such as bipolar junction transistor (BJT), junction FET (JFET) or insulated gate bipolar transistor (IGBT).

In the setting step, a resistor in the circuit layout is considered as a short circuit. Specifically, the present invention omits the voltage drop of the resistor itself as much as possible. Treating the resistor as a short circuit (resistance value as zero ohm) minimizes the number of nodes in the circuit. It should be noted that when computing resources are relatively abundant, or more accurate DC analysis is required, some resistors can be equivalent to voltage drops. For example, a resistor with a resistance greater than a certain value is regulated as a voltage drop; a resistor with a resistance less than a certain value is directly regulated as a short circuit. Therefore, a balance between omitting circuit nodes and verifying simulation accuracy can be balanced, but not limited thereto.

In the setting step, a voltage difference between the anode and the cathode of the diode is equivalent to the diode voltage drop. Specifically, the conventional diode has two external ends, e.g. the anode and the cathode. The voltage difference between the anode and cathode is equivalent to a diode voltage drop, which can simplify the complex diode circuit into voltage nodes to simplify the analysis complexity. It should be noted that conventional diodes can be divided into forward bias and reverse bias. When the diode is forward biased (the anode voltage is greater than the cathode voltage, and the voltage difference is greater than the conduction voltage of the diode), the diode voltage drop from the anode to the cathode of the diode is the conduction voltage of the diode. In this embodiment, the diode voltage drop can even be further simplified to zero volt (0V), thereby further simplifying the complexity of analyzing the diode circuit. When the diode is reverse biased (the anode voltage is less than the cathode voltage), the diode can be programmed to act as an appointed stop point. In the present invention, the “appointed stop point” means that the voltages at two ends are not transmitted to each other end. In other words, when the component is a conventional diode, only one-way conduction from anode to cathode will be considered. However, during reverse bias, the setting step is not limited to this. For example, when the diode is a Zener diode and is reverse biased, the equivalent diode voltage drop from anode to cathode can be equal to the Zener voltage of the Zener diode.

In one embodiment, the setting step may further be based on the following condition: the output end of the inverter in the circuit layout is considered as the appointed stop point. Specifically, a conventional inverter may be composed of one or more transistors, such as an NMOS inverter, a PMOS inverter, a CMOS inverter or a Transistor-transistor logic (TTL) inverter. The output end of the inverter can be considered as the appointed stop point.

In one embodiment, the setting step may further be based on the following condition: the bipolar junction transistor (BJT) in the circuit layout is considered as forward conduction according to the direction of current flow. Specifically, the conventional junction types of bipolar junction transistors can be divided into NPN type and PNP type. Therefore, the connection between the base to the emitter and the base to the collector of the bipolar junction transistor can be considered as a diode, respectively. Therefore, according to the junction type and current direction of the bipolar junction transistor, the base to the emitter and the base to the collector of the bipolar junction transistor can be considered as forward conduction, and the BJT can be equivalent to the diode voltage drop, or considered as reverse bias and considered as the appointed stop point.

In one embodiment, the setting step may further be based on the following condition: the capacitor in the circuit layout is considered as an open circuit, and the inductor in the circuit layout is considered as a short circuit. Specifically, as a passive component, a capacitor is an energy storage component in a DC circuit. The voltage of the capacitor after energy storage is the voltage difference between two coupled ends of the capacitor. Therefore, the capacitor can be expressed as an open circuit (i.e., an appointed stop point). In the DC analysis, an inductor can be viewed as a wire with extremely low resistance and therefore can be individually short-circuited (similar to a resistor). This can also significantly reduce the number of nodes required for subsequent analysis.

When the computing device completes the parameter settings for some or all components in the circuit layout, the adjusted circuit layout can be generated. The computing device may perform the analysis step described in Step S3 on the adjusted circuit layout.

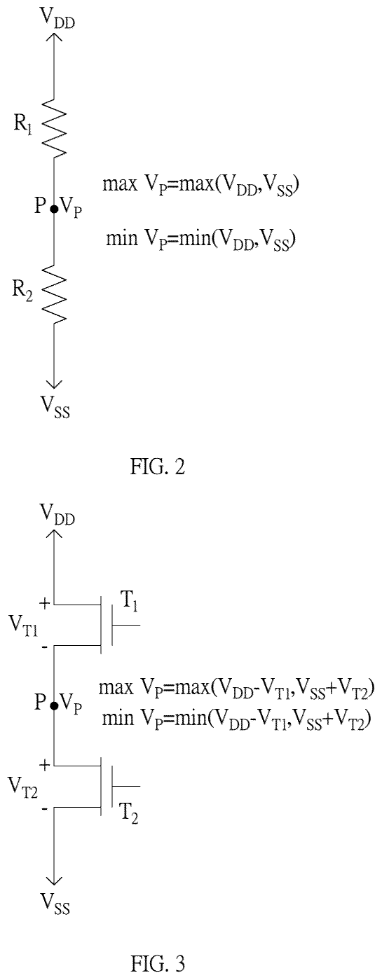

Taking the circuit composed of resistors as an example, please refer to FIG. 2. The resistors (R₁, R₂) in FIG. 2 can be considered as short circuits due to the settings in Step S2. For each node (for example, node P) in the adjusted circuit, the maximum possible voltage value (max V_{P}) and the minimum possible voltage value (min V_{P}) are calculated. Specifically, the preset voltage values (V_{DD}, V_{SS}) shown in FIG. 2 can be directly passed to node P because the resistors (R₁, R₂) are set to short circuits. At this point, the maximum value of the voltage V_{P} of node P (max V_{P}) will be equal to the maximum of the preset voltage values (V_{DD}, V_{SS}), and the minimum value of the voltage V_{P} of node P (min V_{P}) will be equal to the minimum of the preset voltage values (V_{DD}, V_{SS}). It should be noted that the number of preset voltage values can be determined based on the number of preset ports in the circuit, and is not limited to the circuit shown in FIG. 2. In addition, in this DC analysis, the superposition theorem can be used to consider the impact of only one preset voltage value on each node of the circuit at a time, and the remaining preset voltage values can be set to ground. In addition, the calculation can be simplified through conventional circuit calculation methods such as Thevenin's theorem.

Taking the circuit composed of transistors as an example, please refer to FIG. 3. The first transistor (T₁) and the second transistor (T₂) in FIG. 3 have respective first electrodes and third electrodes. Due to the setting of Step S2, the voltage difference between the first electrode and the third electrode in the first transistor (T₁) is equivalent to the first transistor voltage drop (V_{T1}), and the voltage difference between the first electrode and the third electrode in the second transistor (T₂) is equivalent to the second transistor voltage drop (V_{T2}). In Step S3, For each node (for example, node P) in the adjusted circuit, the maximum possible voltage value (max V_{P}) and the minimum possible voltage value (min V_{P}) are calculated. Specifically, because the first and second transistors (T1, T2) are respectively equivalent to the first and second transistor voltage drops (V_{T1}, V_{T2}), each of the preset voltage values (V_{DD}, V_{SS}) shown in FIG. 3 and the voltage V_{P} at node P is different of the first or second transistor voltage drops (V_{T1}, V_{T2}). At this point, the maximum value of the voltage V_{P} of node P (max V_{P}) will be equal to the maximum of the difference (V_{DD}−V_{T1}) between the preset voltage value (V_{DD}) and the first transistor voltage drop (V_{T1}) and the sum (V_{SS}+V_{T2}) of the preset voltage value (V_{SS}) and the second transistor voltage drop (V_{T2}), i.e., max V_{P}=max ((V_{DD}−V_{T1}), (V_{SS}+V_{T2})). On the other hand, the minimum value of the voltage V_{P} of node P (min V_{P}) will be equal to the minimum of the difference (V_{DD}−V_{T1}) between the preset voltage value (V_{DD}) and the first transistor voltage drop (V_{T1}) and the sum (V_{SS}+V_{T2}) of the preset voltage value (V_{SS}) and the second transistor voltage drop (V_{T2}), i.e., min V_{P}=min ((V_{DD}−V_{T1}), (V_{SS}+V_{T2})). It should be noted that in the embodiment shown in FIG. 3, only two transistors are connected in series to simplify the description. When the circuit is modified, a person of ordinary skill in the art can follow the conventional circuit DC analysis methods and the setting step disclosed in the invention to calculate the maximum possible voltage value (max V_{P}) and the minimum possible voltage value (min V_{P}) of node P. In addition, the first transistor voltage drop (V_{T1}) and the second transistor voltage drop (V_{T2}) can be set to the same or different. Specifically, different settings may be made according to the respective channel lengths of the first and second transistors (T₁, T₂) or other transistor parameters, but are not limited thereto.

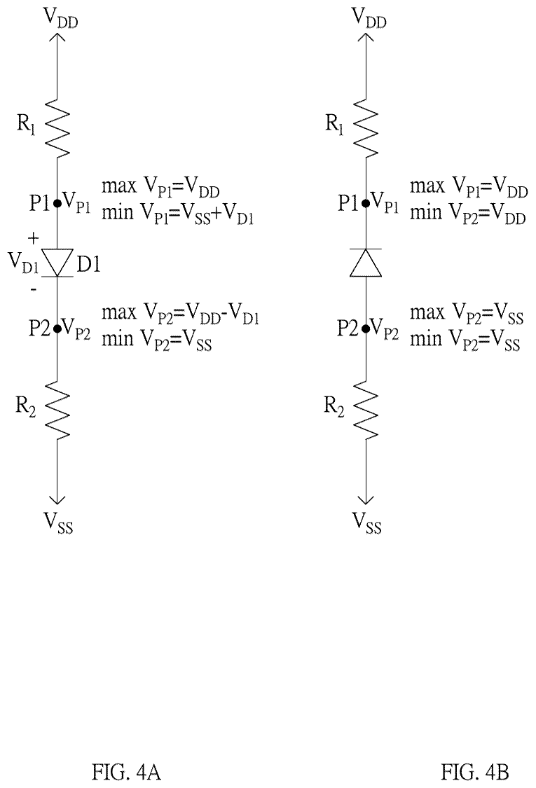

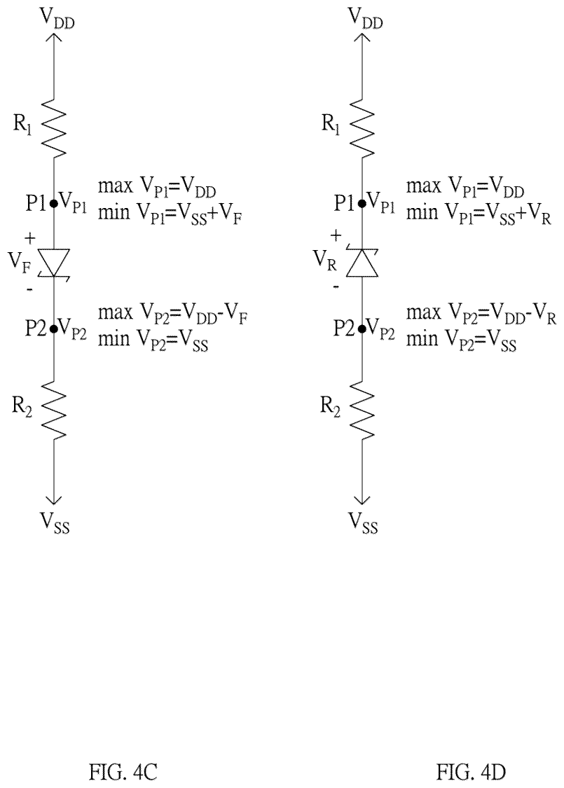

Taking the circuit composed of diodes as an example, please refer to FIG. 4A to FIG. 4D. It should be noted that in the embodiments shown in FIG. 4A to FIG. 4D, in order to simplify the calculation, it is directly assumed that the preset voltage value (V_{DD}) will be greater than the preset voltage value (V_{SS}), and the difference thereof is enough to make the diode (D₁) either forward biased or reverse biased.

In the embodiment shown in FIG. 4A, the circuit is composed of a diode (D₁) and resistors (R₁, R₂), and the diode (D₁) is forward biased. In the adjusted circuit, the resistors (R₁, R₂) are considered short circuits, and the anode to cathode of the diode (D₁) is equivalent to the diode voltage drop (V_{D1}). In Step S3, the maximum possible voltage value and the minimum possible voltage value are calculated for each node (for example, nodes P₁ and P₂) in the adjusted circuit. Specifically, the maximum value (max V_{P1}) of the voltage V_{P1} of node P₁ will be equal to the preset voltage value (V_{DD}), and the minimum value (min V_{P1}) of the voltage V_{P1} of node P₁ will be equal to the sum (V_{SS}+V_{D1}) of the preset voltage value (V_{SS}) and diode voltage drop (V_{D1}). On the other hand, the maximum value (max V_{P2}) of the voltage V_{P2} of node P₂ will be equal to the difference (V_{DD}−V_{D1}) of the preset voltage value (V_{DD}) and diode voltage drop (V_{D1}), and the minimum value (min V_{P2}) of the voltage V_{P2} of node P₂ will be equal to the preset voltage value (V_{SS}).

In the embodiment shown in FIG. 4B, compared to FIG. 4A, the diode (D₁) is reverse biased. In the adjusted circuit, the resistors (R₁, R₂) are considered short circuits, and the anode and cathode of the diode (D₁) can be considered the “appointed stop point”. Specifically, the maximum value (max V_{P1}) of the voltage V_{P1} of node P₁ will be equal to the preset voltage value (V_{DD}). Moreover, due to the setting of the “appointed stop point”, the minimum value (min V_{P1}) of the voltage V_{P1} of node P₁ will be equal to the preset voltage value (V_{DD}) and will not be affected by the preset voltage value (V_{SS}). Similarly, the maximum value (max V_{P2}) and minimum value (min V_{P2}) of the voltage V_{P2} of node P₂ will be equal to the preset voltage value (V_{SS}) and will not be affected by the preset voltage value (V_{DD}).

In the embodiment shown in FIG. 4C, the circuit is composed of a Zener diode (ZD₁) and resistors (R₁, R₂), and the Zener diode (ZD₁) is forward biased. Similar to the situation in FIG. 4A, the Zener diode (ZD₁) is forward biased, and the voltage difference between the anode to cathode of the Zener diode (ZD₁) is equivalent to the diode voltage drop (V_{F}). The maximum value (max V_{P1}) of the voltage V_{P1} of node P₁ will be equal to the preset voltage value (V_{DD}), and the minimum value (min V_{P1}) of the voltage V_{P1} of node P₁ will be equal to the sum (V_{SS}+V_{F}) of the preset voltage value (V_{SS}) and diode voltage drop (V_{F}). On the other hand, the maximum value (max V_{P2}) of the voltage V_{P2} of node P₂ will be equal to the difference (V_{DD}−V_{F}) of the preset voltage value (V_{DD}) and diode voltage drop (V_{F}), and the minimum value (min V_{P2}) of the voltage V_{P2} of node P₂ will be equal to the preset voltage value (V_{SS}).

In the embodiment shown in FIG. 4D, compared to FIG. 4C, the Zener diode (ZD₁) is reverse biased. In the adjusted circuit, the resistors (R₁, R₂) are considered short circuits, and the Zener diode (ZD₁) can be equivalent to the Zener voltage (V_{R}). The maximum value (max V_{P1}) of the voltage V_{P1} of node P₁ will be equal to the preset voltage value (V_{DD}), and the minimum value (min V_{P1}) of the voltage V_{P1} of node P₁ will be equal to the sum (V_{SS}+V_{R}) of the preset voltage value (V_{SS}) and Zener diode voltage (V_{R}). On the other hand, the maximum value (max V_{P2}) of the voltage V_{P2} of node P₂ will be equal to the difference (V_{DD}−V_{R}) of the preset voltage value (V_{DD}) and Zener diode voltage (V_{R}), and the minimum value (min V_{P2}) of the voltage V_{P2} of node P₂ will be equal to the preset voltage value (V_{SS}).

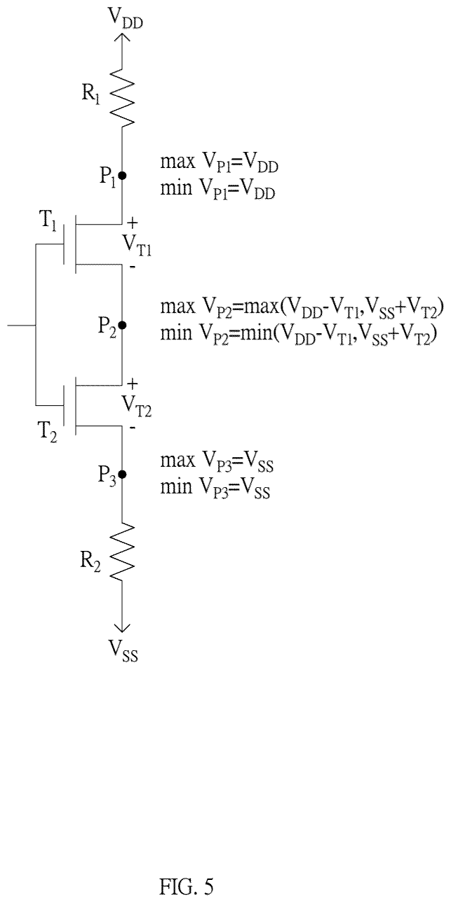

Taking the circuit composed of an inverter as an example, please refer to FIG. 5. In order to simplify the explanation, FIG. 5 is an inverter using a CMOS architecture. However, it should be understood that the concept of this embodiment can be applied to various inverters. Specifically, FIG. 5 is a CMOS inverter composed of PMOS (T₁) and NMOS (T₂). The voltage difference between the first and third electrodes of PMOS (T₁) and NMOS (T₂) can be equivalent to the first transistor voltage drop (V_{T1}) and the second transistor voltage drop (V_{T2}). The output of the CMOS inverter (node P₂) is set to the “appointed stop point”. In the analysis of Step S3, the maximum value (max V_{P1}) of the voltage V_{P1} of the node P₁ will be equal to the preset voltage value (V_{DD}). Moreover, due to the setting of the “appointed stop point”, the minimum value of the voltage V_{P1} of node P₁ (min V_{P1}) will be equal to the preset voltage value (V_{DD}) and will not be affected by the preset voltage value (V_{SS}). Similarly, the maximum value (max V_{P3}) and the minimum value (min V_{P3}) of the voltage V_{P3} of node P₃ will be equal to the preset voltage value (V_{SS}) and will not be affected by the preset voltage value (V_{DD}). Regarding node P₂, the preset voltage values (V_{DD}, V_{SS}) and the first transistor voltage drop (V_{T1}) and the second transistor voltage drop (V_{T2}) need to be considered. Therefore, the maximum value (max V_{P2}) of the voltage V_{P2} of node P₂ will be equal to the maximum of the difference (V_{DD}−V_{T1}) between the preset voltage value (V_{DD}) and the first transistor voltage drop (V_{T1}) and the sum (V_{SS}+V_{T2}) of the preset voltage value (V_{SS}) and the second transistor voltage drop (V_{T2}), i.e., max V_{P2}=max ((V_{DD}−V_{T1}), (V_{SS}+V_{T2})). On the other hand, the minimum value (min V_{P2}) of the voltage V_{P2} of node P₂ will be equal to the minimum of the difference (V_{DD}−V_{T1}) between the preset voltage value (V_{DD}) and the first transistor voltage drop (V_{T1}) and the sum (V_{SS}+V_{T2}) of the preset voltage value (V_{SS}) and the second transistor voltage drop (V_{T2}), i.e., min V_{P2}=min ((V_{DD}−V_{T1}), (V_{SS}+V_{T2})).

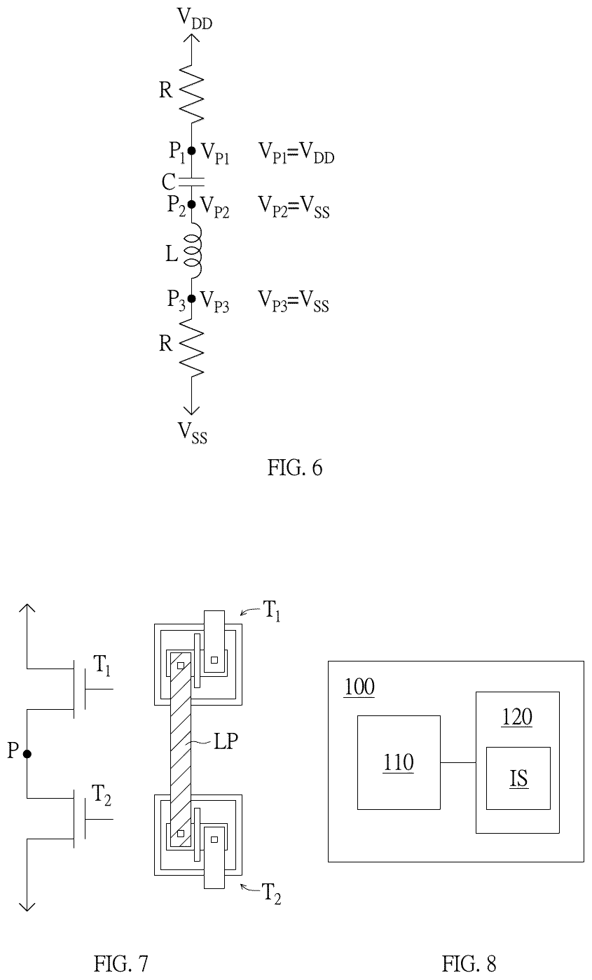

Taking the circuit composed of passive components (for example, capacitor C, inductor L and resistors R) as an example, please refer to FIG. 6. In the circuit shown in FIG. 6, the capacitor C can be considered as an open circuit, and the resistors R and the inductor L can be considered as short circuits. With such settings, the maximum value of the voltage V_{P1} of node P₁ (max V_{P1}) will be equal to the preset voltage value (V_{DD}). Moreover, because the capacitor C has been considered as an open circuit (equivalent to the “appointed stop point”), the minimum value of the voltage V_{P1} of node P₁ (min V_{P1}) will be equal to the preset voltage value (V_{DD}), and will not be affected by the preset voltage value (V_{SS}). Similarly, because the inductor L is set to be short-circuited, the maximum value (max V_{P2}) and the minimum value (min V_{P2}) of the voltage V_{P2} of the node P₂ and the node P₃ are the same as each other and equal to the preset voltage value (V_{SS}), and will not be affected by the preset voltage value (V_{DD}).

It should be noted that the above-mentioned various embodiments are not mutually exclusive, and the settings disclosed in the above-mentioned embodiments can be used comprehensively according to the complexity of the circuit.

After performing the DC analysis on the circuit layout whose parameters for components are set, the maximum possible voltage value and the minimum possible voltage value corresponding to each node on the circuit structure can be obtained. Through the correspondence between the circuit structure and the circuit layout diagram, the maximum possible voltage value and the minimum possible voltage value of the wire segment on the circuit layout can be marked. Specifically, please refer to FIG. 7, which is a schematic diagram of the correspondence between the circuit architecture and the circuit layout diagram. For example, node P may be drawn as wire segment LP in a circuit layout diagram. According to Steps S2 and S3, the maximum possible voltage value (max V_{P}) and the minimum possible voltage value (min V_{P}) of node P can be obtained. At this point, the maximum possible voltage (max V_{P}) and the minimum possible voltage (min V_{P}) are inputted into a predetermined design specification or compared with the rules in the predetermined design specification, to verify whether the wire segment LP complies with the predetermined design specification. On the circuit layout diagram, when the maximum possible voltage value (max V_{P}) and/or the minimum possible voltage value (min V_{P}) exceed the predetermined design specification, the wire segment LP is marked as abnormal.

The circuit layout verification method of the present invention can assign preset parameters to the components in the circuit layout, which can simplify the complexity of the original circuit layout. Simplifying the complexity can effectively reduce the computing resources required by the computer or system and reduce the time required for verification. In addition, verifying the maximum and minimum voltages that the circuit can tolerate and importing them into predetermined design specifications, and marking abnormal locations, can effectively reduce the operating cost of manual judgment required by the prior art.

A second embodiment according to the present invention is a circuit layout verification system. In this embodiment, the circuit layout verification system includes a storage unit and a processor coupled to the storage unit. The storage unit is configured to store an instruction set and a circuit layout. The processor reads the instruction set to execute the circuit layout verification method in the first embodiment of the present application.

Please refer to FIG. 8, which illustrates a circuit layout verification system 100. In this embodiment, the circuit layout verification system 100 includes a storage unit 120 and a processor 110 coupled to the storage unit 120. The storage unit 120 is a data storage medium such as a hard disk, an optical disk, a memory, and a register. The processor 110 is a processing element with computing capabilities such as a central processing unit, a microprocessor, a field programmable gate array (FPGA), an application specific integrated circuit (ASIC), or a system on a chip (SoC). The processor 110 accesses the instruction set IS stored in the storage unit 120 to execute the circuit layout verification methods as described above. The instruction set IS can be various codes of high-level programming language, but is not limited thereto.

Compared with the verification tools used in the prior art, the circuit layout verification system 100 of the present invention is advantageous in quickly detecting perverse points in the layout design. The circuit layout verification system 100 allows layout designers to quickly verify early design results.

The previous description of the invention is provided to enable a person of ordinary skill in the art to make or practice the invention. Various modifications to the invention will be apparent to those people of ordinary skill in the art, and the general principles defined herein may be applied to other variations or the embodiments may be combined with each other or implemented separately without departing from the spirit or scope of the invention. Thus, the present invention is not intended to be limited to the examples described herein but is to be accorded the widest scope consistent with the principles and novel features of the invention herein.

What is claimed is:

1. A circuit layout verification method in a computing device, comprising:
reading a circuit layout;
setting parameters for components in the circuit layout, based on that:
a voltage difference between a first electrode and a third electrode of a transistor in the circuit layout is equivalent to a transistor voltage drop,
a resistor in the circuit layout is considered as a short circuit, and
a voltage difference between an anode and a cathode of a diode in the circuit layout is equivalent to a diode voltage drop;
according to a preset voltage value of at least one port in the circuit layout, performing a direct current (DC) analysis on the circuit layout after the setting is performed to calculate a maximum possible voltage value and a minimum possible voltage value of a wire segment in the circuit layout; and
inputting the maximum possible voltage value and the minimum possible voltage value into a predetermined design specification, wherein when the maximum possible voltage value or the minimum possible voltage value exceeds the predetermined design specification, the wire segment is marked as abnormal.

2. The method of claim 1, wherein the transistor voltage drop is 0V.

3. The method of claim 1, wherein the diode voltage drop is 0V.

4. The method of claim 1, wherein the setting is further based on that:
an output end of an inverter in the circuit layout is considered as an appointed stop point.

5. The method of claim 1, wherein the setting is further based on that:
a capacitor in the circuit layout is considered as an open circuit, and
an inductor in this circuit layout is considered as a short circuit.

6. The method of claim 1, wherein the setting is further based on that:
a bipolar junction transistor in this circuit layout is considered as a forward conduction according to a direction of current flow.

7. A circuit layout verification system, comprising:
a storage unit configured to store an instruction set and a circuit layout; and
a processor coupled to the storage unit, the processor configured to read the instruction set to perform the following operations:
reading a circuit layout;
setting parameters for components in the circuit layout, based on that:
a voltage difference between a first electrode and a third electrode of a transistor in the circuit layout is equivalent to a transistor voltage drop,
a resistor in the circuit layout is considered as a short circuit, and
a voltage difference between an anode and a cathode of a diode in the circuit layout is equivalent to a diode voltage drop;
according to a preset voltage value of at least one port in the circuit layout, performing a direct current (DC) analysis on the circuit layout after the setting is performed to calculate a maximum possible voltage value and a minimum possible voltage value of a wire segment in the circuit layout; and
inputting the maximum possible voltage value and the minimum possible voltage value into a predetermined design specification, wherein when the maximum possible voltage value or the minimum possible voltage value exceeds the predetermined design specification, the wire segment is marked as abnormal.

8. The system of claim 7, wherein the transistor voltage drop is 0V.

9. The system of claim 7, wherein the diode voltage drop is 0V.

10. The system of claim 7, wherein the setting is further based on that:
an output end of an inverter in the circuit layout is considered as an appointed stop point.

11. The system of claim 7, wherein the setting is further based on that:
a capacitor in the circuit layout is considered as an open circuit, and
a inductor in this circuit layout is considered as a short circuit.

12. The system of claim 7, wherein the setting is further based on that:
a bipolar junction transistor in this circuit layout is considered as a forward conduction according to a direction of current flow.
